(19) United States
(12) Patent Application Publication
(10) Pub. No.: US 2024/0170678 A1
(43) Pub. Date: May 23, 2024

(54) ANODE AND SECONDARY BATTERY COMPRISING THE SAME

(71) Applicants: Hyundai Motor Company, Seoul (KR); Kia Corporation, Seoul (KR); SEOUL NATIONAL UNIVERSITY R&DB FOUNDATION, Seoul (KR)

(72) Inventors: Yong Il Cho, Seoul (KR); Geun Ho Choi, Suwon (KR); Hannah Song, Ansan (KR); Hyun Jin Kim, Daegu (KR); Hyeon Ha Lee, Anyang (KR); Chan Bum Park, Suwon (KR); Jang Wook Choi, Seoul (KR); Tae Geun Lee, Ansan (KR); Ji Woo An, Seoul (KR)

(21) Appl. No.: 18/119,442

(22) Filed: Mar. 9, 2023

(30) Foreign Application Priority Data
Nov. 23, 2022 (KR) 10-2022-0158027

(51) Int. Cl. H01M 4/66; H01M 4/62

(52) U.S. Cl. CPC H01M 4/667; H01M 4/623; H01M 2220/20

(57) ABSTRACT

Disclosed are an anode including a core part and a binder and a secondary battery including the same. Particularly, a coating layer including a polymer is provided between the core part and the binder and thus blocks electron transport paths from the core part to the binder. Thereby, decomposition of the binder is suppressed, and thus, the charge capacity and the initial Coulombic efficiency of the secondary battery are increased.

### CROSS-REFERENCE TO RELATED APPLICATION

This application claims under 35 U.S.C. § 119(a) the benefit of priority to Korean Patent Application No. 10-2022-0158027 filed on Nov. 23, 2022, the entire contents of which are incorporated herein by reference.

### TECHNICAL FIELD

The present disclosure relates to an anode and a secondary battery including the same.

### BACKGROUND

In order to improve the energy density of a secondary battery, increase in electrode thicknesses is needed, but conventional wet process-based electrode coating technology has a limit in increase in electrode thicknesses and thus, conventional dry process-based electrode coating technology is being spotlighted. Further, the dry process is essential to recover a solvent used to prepare a slurry. When such a dry process is used, it is relatively easy to form a thick electrode. Further, the dry process may be economical and eco-friendly, because a solvent is not used, and may expect improvement in a process speed.

Polytetrafluoroethylene (PTFE) may be applicable as a binder in to the dry process but may cause electrochemical decomposition reaction at about 0.5 V (vs. Li/Li+). The reason for this is that PTFE has a molecular structure in which a large number of fluorine atoms is bonded to carbon atoms, and is thus unstable. Therefore, development of technology for solving the above problem is required.

The above information disclosed in this Background section is only for enhancement of understanding of the background of the invention and therefore it may contain information that does not form the prior art that is already known in this country to a person of ordinary skill in the art.

### SUMMARY

In preferred aspects, provide is an anode including a core part and a binder, and in the anode, the electrochemical decomposition reaction of a binder may be reduced by blocking electron transport paths from core part to the binder by including a coating layer including a polymer between the core part and the binder.

In addition, the anode may increase initial Columbic efficiency by suppressing decomposition of a binder by including a coating layer onto core part.

In an aspect, provided is an anode including an anode active material including core part including an anode material, and a coating layer configured to coat at least a part of a surface of each of the core part, and a binder. The coating layer includes a polymer including one or more selected from the group consisting of polyvinylidene fluoride (PVDF), polytrifluoroethylene (PTrFE), polychlorofluoroethylene (PCFE), abd polychlorotrifluoroethylene (PCTFE).

The anode material may include one or more selected from the group consisting of silicon (Si), germanium (Ge), and a silicon (Si)-carbon (C) composite.

The polymer may have electronic conductivity of equal to or less than about 10'S/cm.

The polymer may have a dielectric constant of equal to or greater than about 5.

The coating layer satisfies Relation 1 below,

Binder Content×0.1<Coating Layer Content<Binder Content×65.5 [Relation 1]

The binder may include one or more selected from the group consisting of polytetrafluoroethylene (PTFE), polyvinylidene fluoride (PVDF), cellulose, styrene-butadiene rubber (SBR), polyimide, polyacrylic acid, alkali polyacrylate, poly(methyl methacrylate) (PMMA), and polyacrylonitrile (PAN).

The anode may include an amount of about 50 wt % to 99.8 wt % of the core part, an amount of about 0.1 wt % to 49.9 wt % of the coating layer, and an amount of about 0.1 wt % to 1.5 wt % of the binder based on 100 wt % of the anode.

The anode may further include a conductive material.

The anode may include an amount of about 0.1 wt % to 5 wt % of the conductive material based on 100 wt % of the anode.

In another aspect, the present disclosure provides a secondary battery including a cathode, the above-described anode, and an electrolyte interposed between the cathode and the anode.

An initial Coulombic efficiency of the secondary battery may be equal to or greater than about 83%.

Also provided is a vehicle including the secondary battery as described above.

Other aspects of the invention are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows a longitudinal-sectional view of an exemplary secondary battery according to an exemplary embodiment of the present disclosure;

FIG. 2 shows a schematic longitudinal-sectional view of an exemplary anode according to an exemplary embodiment of the present disclosure;

FIG. 3 is a graph representing initial Coulombic efficiencies of secondary batteries manufactured according to Examples and Comparative Examples of the present disclosure; and

FIG. 4 is a graph representing lifespans of the secondary batteries manufactured according to Example 2 and Comparative Example 1 of the present disclosure.

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the invention. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, an anode and a secondary battery including the same will be described in detail.

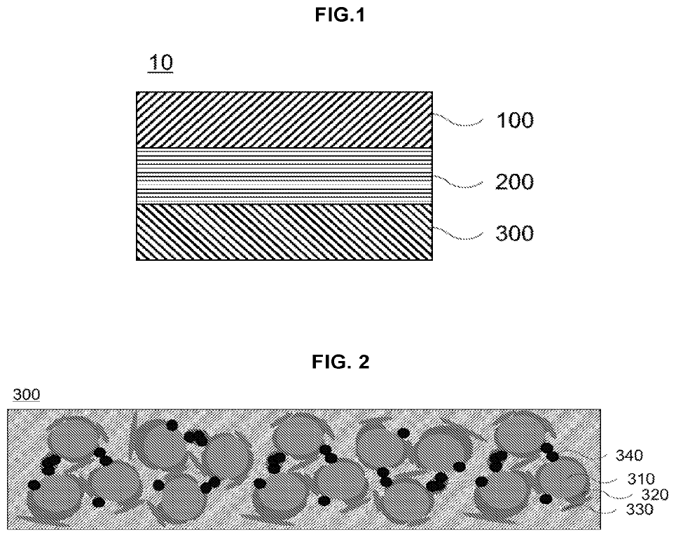

FIG. 1 shows a schematic longitudinal-sectional view of an exemplary secondary battery according to an exemplary embodiment of the present disclosure. FIG. 2 shows a schematic longitudinal-sectional view of an exemplary anode according to an exemplary embodiment of the present disclosure.

As shown in FIGS. 1 and 2, a secondary battery 10 may include a cathode 100, an electrolyte 200, and an anode 300. The cathode 100 may include lead. The electrolyte 200 may be provided on the cathode 100. The cathode 100 and the anode 300 may be spaced apart from each other by the electrolyte 200. Although not shown in the drawings, the secondary battery 10 according to one embodiment of the present disclosure may further include separators.

The initial Coulombic efficiency of the secondary battery 10 may be equal to or greater than about 83%.

The operating voltage range of the secondary battery 10 may be equal to or less than about 1 V (vs. Li/Li+).

The cathode 300 may include core part 310, a coating layer 320, and a binder 330. The cathode 300 may further include a conductive material 340.

The core part 310 may include an anode material. The anode material may include one or more selected from the group consisting of silicon (Si), germanium (Ge), and a silicon (Si)-carbon (C) composite. The silicon-carbon composite may be a composite in which the surfaces of silicon secondary particles, formed by agglomeration of silicon particles, are coated with a carbon-based material. The carbon-based material may include one or more selected from the group consisting of natural graphite, artificial graphite, and amorphous carbon.

The anode 300 may include an amount of about 50 wt % to 99.8 wt % of the core part 310 based on 100 wt % of the anode 300. When the content of the core part 310 is less than about 50 wt %, electron transport paths between the core part 310 are not sufficiently formed, some of the core part 310 may not receive electrons, and thus, the charge and discharge capacities of the anode 300 may be reduced.

The coating layer 320 may include a polymer. The polymer is not limited to a specific kind as long as it is electrochemically stable. That is, the polymer used in the present disclosure is not limited to a specific kind as long as it does not cause oxidation and/or reduction reaction within the operating voltage range of a secondary battery to which the polymer is applied (for example, 0-5 V vs. Li/Li+). The polymer may include, for example, one or more selected from the group consisting of polyvinylidene fluoride (PVDF), polytrifluoroethylene (PTrFE), polychlorofluoroethylene (PCFE), and polychlorotrifluoroethylene (PCTFE).

The coating layer 320 may coat at least a part of the surface of each of the core part 310.

The coating layer 320 may be located between the core part 310 and the binder 330. Particularly, the core part 310 and the binder 330 may not come into contact with each other by the coating layer 320. When an anode active material which is charged or discharged at 1 V or less (vs. Li/Li+) and the binder 330, such as PTFE, are used together, PTFE reacts with Li+ and is thus decomposed into LiF during a charging or discharging process. Therefore, the present disclosure is characterized in that the coating layer 320 including the polymer is provided between the core part 310 and the binder 330 so as to block paths through which electrons are transported from the core part 310 to the binder 330. Thereby, the electrochemical decomposition reaction rate of PTFE is reduced and the amount of Li⁺ consumed is reduced, thus being capable increasing the initial Coulombic efficiency of the secondary battery.

The electronic conductivity of the polymer may be equal to or less than about 10⁻⁶ S/cm. It is known that, so as to suppress electrochemical reaction through blocking of electrons by a coating layer generally having a thickness measured in it is sufficient that the electronic conductivity of a polymer included in the coating layer may be equal to or less than about 10⁻³ S/cm. However, since the coating layer 320 has a thickness measured in nm which is 1/1000of the electronic conductivity of the polymer included in the coating layer 320 may be equal to or less than 10⁻⁶ S/cm which is 1/1000of the electronic conductivity of the polymer included in the conventional coating layer.

The polymer may block the electron transport paths from the core part 310 to the binder 330 through the above-described low lithium ion conductivity.

The dielectric constant of the polymer at a measurement frequency of 1 kHz may be equal to or greater than about 5. For example, the dielectric constant of the polymer at the measurement frequency of 1 kHz may be about 5 to 60. The polymer having the above dielectric constant range may reduce increase in the resistance of the anode 300 and reduction in the capacity of the secondary battery 10 due to disturbance to movement of lithium ions by the coating layer 320.

The coating layer 320 may satisfy Relation 1 below.

Binder Content×0.1<Coating Layer Content<Binder Content×65.5 [Relation 1]

When the content of the coating layer 320 deviates from the range of Reaction 1 above, a coating material may not sufficiently protect the core part 310 and may thus not alleviate the electrochemical decomposition reaction of the binder 330, or the coating layer 320 may greatly disturb movement of lithium ions and may thus cause problems, such as increase in the resistance of the anode 300.

The anode 300 may include an amount of about 0.1 wt % to 1.5 wt % of the coating layer 320 based on 100 wt % of the anode 300. When the content of the coating layer 320 is greater than about 1.5 wt %, the thick coating layer 320 disturbs movement of lithium ions, and may thus cause reduction in the capacity of the secondary battery 10 due to increase in the resistance of the anode 300.

The binder 330 may enhance agglomeration in the anode 300. The binder 330 may include, for example, one or more selected from the group consisting of polytetrafluoroethylene (PTFE), polyvinylidene fluoride (PVDF), cellulose, styrene-butadiene rubber (SBR), polyimide, polyacrylic acid, alkali polyacrylate, poly(methyl methacrylate) (PMMA), and polyacrylonitrile (PAN), and particularly, may be polytetrafluoroethylene (PTFE), without being limited thereto.

The anode 300 may include an amount of about 0.1 wt % to 49.9 wt % of the binder 330 based on 100 wt % of the anode 300. When the content of the binder 330 is greater than about 49.9 wt %, the binder 330 disturbs movement of lithium ions, and may thus cause increase in the resistance of the anode 300 and reduction in the capacity of the secondary battery 10.

The anode 300 may further include the conductive material 340.

The conductive material 340 may improve conductivity of the anode 300. The conducive material 340 may be, for example, carbon block, such as Ketjen black or acetylene black, natural graphite, artificial graphite, or carbon nanotubes (CNTs), and is not limited to a specific material as long as it may increase conductivity of the anode 300.

The anode 300 may include an amount of about 0.1 wt % to 5 wt % of the conductive material 340 based on 100 wt % of the anode 300. When the content of the conductive material 340 is less than about 0.1 wt %, the amount of the conductive material 340 is not sufficient, and may thus cause difficulty in smoothly generating the electron transport paths in the anode 300. Thereby, the capacity of the secondary battery 10 may be reduced, compared to the case in which the anode 300 includes a sufficient amount of the conductive material 340. Further, when the content of the conductive material 340 is greater than about 5 wt %, the conductive material 340 disturbs movement of lithium ions in the anode 300, and may thus cause increase in the resistance of the anode 30 and reduction in the capacity of the secondary battery 10.

### EXAMPLE

Hereinafter, the present disclosure will be described in more detail through the following examples. The following examples serve merely to exemplarily describe the present disclosure, and are not intended to limit the scope of the invention.

### Example 1

Manufacture of Anode

A 5 wt % coating solution was prepared by dissolving polytrifluoroethylene (PTrFE) as a coating polymer in 2-butanone as a solvent. Here, 0.1 wt % of PTrFE was used based on the total weight of an anode active material, and the coating solution was stirred using a mixer. The anode active material was manufactured by forming a coating layer on core part including an anode material by coating the core part with the coating solution including PTrFE. The anode active material was first dried at a temperature of 110° C. for 1 hour, and was then dried at a temperature of 60° C. for 24 hours. Powder acquired by drying was ground into fine particles, and the acquired anode active material particles were separated by size using sieves. An anode was manufactured by mixing the anode active material particles with 3 wt % of PTFE as a binder.

Manufacture of Secondary Battery

A coin cell as a secondary battery was manufactured from the anode manufactured by the above-described method, using lithium metal a counter electrode.

### Example 2

An anode and a secondary battery were manufactured in the same manner as in Example 1, except that 0.5 wt % of PTrFE as a coating polymer was used.

### Example 3

An anode and a secondary battery were manufactured in the same manner as in Example 1, except that 1.0 wt % of PTrFE as a coating polymer was used.

### Example 4

An anode and a secondary battery were manufactured in the same manner as in Example 1, except that 1.5 wt % of PTrFE as a coating polymer was used.

### Comparative Example 1

An anode and a secondary battery were manufactured in the same manner as in Example 1, except that a coating layer including PTrFE as a coating polymer was not formed on core part.

### Comparative Example 2

An anode and a secondary battery were manufactured in the same manner as in Example 1, except that 2.0 wt % of PTrFE as a coating polymer was used.

### Test Example 1: Measurement of Initial Coulombic Efficiency

Each of the secondary batteries manufactured according to Examples 1 to 4 and Comparative Examples 1 and 2 was charged at 0.1 C constant current (CC) until charge voltage reaches 10 mV, and was then charged at constant voltage (CV) until charge current reaches 0.05 C, and thereby, charging of the corresponding secondary battery in the first cycle was performed. Thereafter, each of the secondary batteries was discharged at 0.1 C constant current (CC) until discharge voltage reaches 1.5 V, and the discharge capacity of the corresponding secondary battery in the first cycle was measured. The initial Columbic efficiency of the corresponding secondary battery was calculated from the charge capacity and the discharge capacity in the first cycle.

Results of the calculation are set forth in Table 1 below.

TABLE 1

| | Initial Coulombic |
|---|---|
| | efficiency |
| Example | (CE, unit: %) |
| Comparative Example 1 | 82.90 |
| (3 wt % of binder, 0.0 wt % of polymer (PTrFE)) | |
| Example 1 | 83.70 |
| (3 wt % of binder, 0.1 wt % of polymer (PTrFE) | |
| Example 2 | 84.50 |
| (3 wt % of binder, 0.5 wt % of polymer (PTrFE)) | |
| Example 3 | 84.45 |
| (3 wt % of binder, 1.0 wt % of polymer (PTrFE) | |
| Example 4 | 83.80 |
| (3 wt % of binder, 1.5 wt % of polymer (PTrFE) | |
| Comparative Example 2 | 82.20 |
| (3 wt % of binder, 2.0 wt % of polymer (PTrFE) | |

Initial Columbic Efficiency: (Discharge Capacity in First Cycle/Charge Capacity in First Cycle) x100

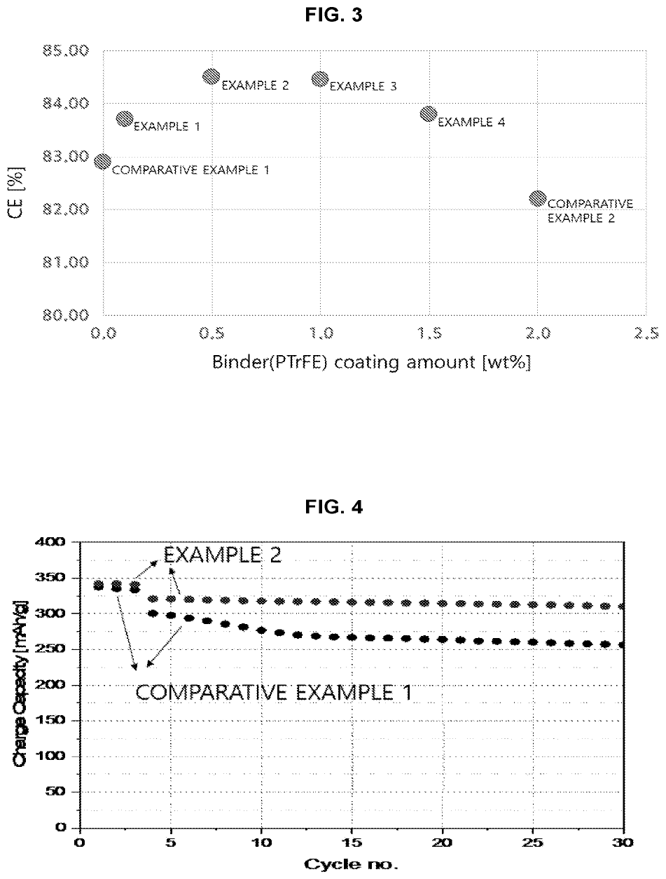

FIG. 3 is a graph representing initial Coulombic efficiencies of secondary batteries manufactured according to Examples and Comparative Examples of the present disclosure. Referring to FIG. 3 and Table 1, the initial Columbic efficiencies of the secondary battery manufactured according to Comparative Example 1, in which a coating layer is not formed, and the secondary battery manufactured according to Comparative Example 2, in which the content of the coating layer exceeds 1.5 wt %, are reduced, compared to the initial Columbic efficiencies of the secondary batteries manufactured according to Examples 1 to 4.

Thereby, when a coating layer is not formed, decomposition of a binder occurs, and, when the amount of the coating polymer is excessive, the capacity of the secondary battery is reduced due to increase in the resistance of the anode caused by reduction in the electrical conductivity of the anode.

### Test Example 2: Measurement of Cycle Characteristics

A charge and discharge test to measure the cycle characteristics of the secondary batteries manufactured by Example 2 and Comparative Example 1 was performed. The charge and discharge test was performed at constant current (CC).

Results of the test are set forth in Table 2 below.

TABLE 2

Cycle No.

| | | |
|---|---|---|
| 1 | 2 | 3 |

| | |
|---|---|
| | Charge Capacity (unit: mAh/g)/Initial |
| Example | Coulombic Efficiency (CE, unit: %) |

| | | | |
|---|---|---|---|
| Comp. Example 1 | 337.67/80.92 | 335.05/98.20 | 333.44/98.81 |
| Example 2 | 342.07/85.14 | 342.03/98.68 | 341.23/99.18 |

FIG. 4 is a graph representing lifespans of the secondary batteries manufactured according to Example 2 and Comparative Example 1 of the present disclosure. As shown in FIG. 4 and Table 2, the secondary battery manufactured according to Example 2 has an excellent charge capacity and excellent initial Coulombic efficiency compared to the secondary battery manufactured according to Comparative Example 1, because the coating layer including PTrFE serving as the coating polymer alleviates the electrochemical decomposition reaction of PTFE serving as the binder.

Therefore, in the anode and the secondary battery including the same according to various exemplary embodiments of the present disclosure, the coating layer including the polymer is provided between the core part and the binder, and thus may block paths through which electrons are transported from the core part to the binder. Thereby, decomposition of the binder may be suppressed, and thus, the charge capacity and the initial Coulombic efficiency of the secondary battery may be increased.

As is apparent from the above description, an anode and a secondary battery including the same according to the present disclosure may have increased initial Columbic efficiency and improved cycle characteristics.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. An anode comprising:
an anode active material comprising a core part and a coating layer, and
a binder,
wherein the core part comprising an anode material,
wherein the coating layer is configured to coat at least a part of a surface of each of the core part; and
wherein the coating layer comprises a polymer comprising one or more selected from the group consisting of polyvinylidene fluoride (PVDF), polytrifluoroethylene (PTrFE), polychlorofluoroethylene (PCFE), and polychlorotrifluoroethylene (PCTFE).

2. The anode of claim 1, wherein the anode material comprises one or more selected from the group consisting of silicon (Si), germanium (Ge), and a silicon (Si)-carbon (C) composite.

3. The anode of claim 1, wherein the polymer has electronic conductivity of equal to or less than about 10⁻⁶ S/cm.

4. The anode of claim 1, wherein the polymer has a dielectric constant of equal to or greater than about 5.

5. The anode of claim 1, wherein the coating layer satisfies Relation 1 below,
Binder Content×0.1<Coating Layer Content<Binder Content×65.5 [Relation 1]

6. The anode of claim 1, wherein the binder comprises one or more selected from the group consisting of polytetrafluoroethylene (PTFE), polyvinylidene fluoride (PVDF), cellulose, styrene-butadiene rubber (SBR), polyimide, polyacrylic acid, alkali polyacrylate, poly(methyl methacrylate) (PMMA), and polyacrylonitrile (PAN).

7. The anode of claim 1, comprising, based on 100 wt % of the anode:
an amount of about 50 wt % to 99.8 wt % of the core part;
an amount of about 0.1 wt % to 49.9 wt % of the coating layer; and
an amount of about 0.1 wt % to 1.5 wt % of the binder.

8. The anode of claim 1, further comprising a conductive material.

9. The anode of claim 8, comprising an amount of about 0.1 wt % to 5 wt % of the conductive material based on 100 wt % of the anode.

10. A secondary battery comprising:
a cathode;
an anode of claim 1; and
an electrolyte disposed between the cathode and the anode.

11. The secondary battery of claim 10, wherein initial Coulombic efficiency of the secondary battery is equal to or greater than about 83%.

12. A vehicle comprising a secondary battery of claim 10.
